(19) United States
(12) Patent Application Publication
(10) Pub. No.: US 2004/0183405 A1
(43) Pub. Date: Sep. 23, 2004

(54) Actuator unit comprising at least two actuator elements

(76) Inventor: Lorand D'Ouvenou, Bernhardswald (DE)

Correspondence Address: Andreas Grubert, Baker Botts L.L.P., One Shell Plaza, 910 Louisiana, Houston, TX, 77002-0495, US

(21) Appl. No.: 10/816,961

(22) Filed: Apr. 2, 2004

Related U.S. Application Data
(63) Continuation of application No. PCT/DE02/03720, filed on Oct. 1, 2002.

(30) Foreign Application Priority Data
Oct. 2, 2001 (DE) 101 48 603.0

(51) Int. Cl. H02N 2/04

(52) U.S. Cl. 310/328

(57) ABSTRACT

An actuator unit comprises two actuator elements (8, 9), each of which undergoes a length modification during electric activation and which are connected to a control device (6) by means of an interactive connection. An actuator housing (4), which surrounds the actuator elements (8, 9) is connected to the latter in a positive and/or friction fit. A vectorial sum of the mass impulses of the two actuator elements (8, 9) is approximately equal to zero at any one time.

### CROSS REFERENCE TO RELATED APPLICATION

This application is a continuation of copending International Application No. PCT/DE02/03720 filed Oct. 1, 2002 which designates the United States, and claims priority to German application no. 101 48 603.0 filed Oct. 2, 2001.

### TECHNICAL FIELD OF THE INVENTION

The invention relates to an actuator unit comprising at least two actuator elements, in particular for use as an actuator for a fuel injection valve of an internal combustion engine.

### DESCRIPTION OF THE RELATED ART

Accumulator-type (common rail) injection systems are increasingly used for the fuel supply in internal combustion engines. In said systems, very high injection pressures and high switching speeds are employed by the fuel metering devices, known as injectors. With storage injection systems of this kind, fuel is injected into the combustion chambers of the internal combustion engine by means of fuel injectors.

The fuel injector generally comprises an injection nozzle which is opened and closed hydraulically by a servo valve in order to precisely define the timing characteristics of the injection of fuel into the combustion chamber. In said process the servo valve is operated by an electrically controlled actuator, the use of piezoelectrically operated actuators in particular having proven to be advantageous in order to achieve sufficiently short switching times. In a piezoelectrically operated actuator of this kind, a change in length of a piezo stack is triggered by application of an electrical voltage, said length change being transmitted—where appropriate by means of a lever device—to the servo valve. The latter opens and closes the injection nozzle in turn.

The extremely fast switching piezoelectric actuators with switching times in the region of less than 200 μs and the associated high increases in velocity are, however, capable of inducing high-frequency mechanical oscillations and introducing these into the housing enclosing the piezo actuator. These vibrations are spectrally very broadband and generate a high measure of structure-borne sound up into a high-frequency range. The structure-borne sound vibrations are propagated along the injector body and are introduced into the cylinder head of the internal combustion engine. However, these mechanical vibrations on the surface of the injector body and the cylinder head lead to considerable disturbance noises which can have a negative effect on driving comfort. As combustion engines are becoming quieter and quieter, an injection valve whose noise generation is audibly superimposed on the overall noise of an engine is not acceptable on comfort grounds.

In order to reduce the noise emissions from electrically operated actuators, the actuators can be provided with additional soundproofing covers. A soundproofed actuator unit of this kind with a piezo element is known for example from the unexamined German patent specification 199 46 965 A1. Such passive soundproofing measures for the structure-borne sound excitations described are only of very limited effectiveness, however.

### SUMMARY OF THE INVENTION

An object of the invention is to provide an actuator unit, in particular an actuator for a fuel injection valve of an internal combustion engine, which avoids the disadvantages in the prior art and exhibits a minimum level of noise emission.

This object can be achieved by an actuator unit comprising at least two actuator elements which when electrically activated each experience a change in length, which are connected to a control device by means of an interactive connection, and an actuator housing which encloses the actuator elements and which is connected to the actuator elements by means of a positive and/or friction fit, wherein a vectorial sum of the mass impulses of the at least two actuator elements is approximately zero at any given time.

A first and a second actuator element can be each disposed essentially opposite each other with intersecting longitudinal axes. A vectorial sum of the longitudinal movements of the at least two actuator elements can be approximately zero at any given time. A first and a second actuator element can be each disposed opposite each other with coincident longitudinal axes. A first and a second end face of the first and second actuator element respectively can be supported in the actuator housing, and a third and fourth end face of the actuator elements respectively act upon a transmission medium. The transmission medium can be part of a transmission device and acts upon the control device. The transmission medium can be part of a hydraulic transmission device and acts upon the control device. The transmission medium can be part of a hydraulic transmission device and acts upon the control device. The direction of the axial movements of the first and second actuator elements can be oriented essentially normal to the direction of movement of the control device. The first and the second end face of the first and second actuator element respectively can be supported in the actuator housing and the third end face of the first actuator element may act directly or indirectly upon the control device. The directions of the axial movements of the first and second actuator element as well as the direction of movement of the control device can be oriented in each case axially parallel to one another. Each of the actuator elements can be a piezoelectric actuator element. Each of the actuator elements can be a magnetostrictive actuator element. The actuator unit can be an actuator of a fuel injection valve. The actuator elements of the actuator unit can be controlled separately from each other and individually.

In order to achieve this object of the invention, an actuator unit comprises at least two actuator elements, each of which undergoes a length change when electrically activated and which are connected to an control device by means of an interactive connection. The actuator unit additionally comprises an actuator housing enclosing the actuator elements which is connected to each of the actuator elements both positively and by means of a friction fit.

According to the invention, a vectorial sum of the mass impulses of the at least two actuator elements is approximately equal to zero at any given time. In other words, the products from the masses and the speeds of the two actuator elements add up vectorially to a total of zero.

This actuator unit according to the invention has the advantage of significantly reduced noise radiation. The actuator element, which is normally present only in a single embodiment, is supplemented by a second actuator element which is mounted inversely with respect to the first actuator element in terms of its direction of movement and is deflected in the opposite direction when activated electrically. By this means the resulting external vibration energy of the actuator unit is approximately zero in the ideal case. Although this ideal case is not actually achieved in reality, the improvements achieved in this way are sufficient to produce a significant reduction in the structure-borne noise generated, more especially in the particularly disturbing frequency ranges between 4 and 8 kHz.

A first embodiment of the actuator unit according to the invention provides that a first and a second actuator element are disposed opposite each other with intersecting longitudinal axes in each case. This embodiment has the particular advantage that the two actuator elements reciprocally dampen each other's noise radiation under identical electrical activation. The actuator elements can for example be arranged in a V shape, which may be of advantage in terms of a compact design. Provided sufficient installation space is available, the actuators can also be arranged opposite each other.

A further embodiment of the actuator unit according to the invention provides that a vectorial sum of the longitudinal movements of the at least two actuator elements is approximately equal to zero at any given time. This embodiment has the particular advantage that the two actuator elements reciprocally dampen each other's noise radiation under identical electrical activation.

A further embodiment of the actuator unit according to the invention provides that a first and a second actuator element are disposed facing each other in each case with coincident longitudinal axes. This embodiment has the particular advantage that the two actuator elements reciprocally dampen each other's noise emissions under identical electrical activation.

In this way significant improvements in terms of the externally radiated airborne and structure-borne noise of the actuator unit can be achieved in spite of the double energy input into the system. A further advantage of the actuator unit according to the invention is that unmodified control electronics can be used.

In a further embodiment of the invention, a first and second end face of the first and second actuator element respectively are supported in the actuator housing. In addition, a third and fourth end face of the actuator elements act in each case upon a transmission medium. With this further embodiment of the invention it is particularly advantageous that the total combined kinetic energy of the two actuator elements can be used to activate an control device. The transmission medium can preferably be part of a hydraulic transmission device and act upon the control device. This produces in particular the advantage of a very precise and delay-free transmissibility of the length changes of the two actuator elements to the desired longitudinal movement of the control device. In the ideal case it is even possible to dispense with an otherwise frequently necessary leverage transmission arrangement which effects a transmission of the often only slight deflections of an actuator element to the necessary control movement of a servo valve.

According to a further embodiment of the invention, the direction of the axial movements of the first and second actuator elements are in each case oriented essentially vertically relative to the direction of movement of the control device. In this case the longitudinal movements of the two actuator elements run in opposite directions and result in the mass impulses released by them largely canceling each other out in their effect. All that remains is a resulting mass impulse which is released by the moved mass of the transmission medium. This residual impulse acting in the vertical direction relative to the longitudinal movement direction of the actuator elements is in any case considerably less than a known type of injector design. As a result only very slight vibrations are given off externally by the actuator element. A further advantage of this embodiment is based on the fact that as a result of the two actuator elements operating in parallel there is no increased energy requirement for noise attenuation compared with the use of just one actuator element. Where appropriate it may even be possible to use actuator elements of shorter design, which can have many different advantages in terms of the installation of the actuator unit in constricted space conditions.

According to an alternative embodiment of the invention, the first and second end face of the first and second actuator element respectively is supported in the actuator housing. In addition, according to this alternative embodiment of the invention, the third end face of the first actuator element acts directly or indirectly upon the control device. This embodiment has the advantage of a simple and compact design which necessitates only few structural modifications compared with a conventional design.

According to one embodiment of the invention, the directions of the axial movements of the first and second actuator elements and the direction of movement of the control device are in each case oriented axially parallel to one another, which has the associated advantage of an approximately ideal mass balance which leads to the considerable reduction in the external noise radiation of the actuator unit. Examples of suitable actuator elements are piezoelectric units or magnetostrictive actuator elements.

The actuator unit according to the invention is suitable in particular as an actuator for a fuel injection valve.

To sum up, the following aspects of the invention result. Thanks to the additional assembly of a second piezo element in an existing actuator unit which moves in precisely the opposite direction to the actual drive piezo, vibrations which are transferred to the engine block and radiated can be substantially reduced, resulting overall in a more pleasant acoustic pattern of the injection valve taken on its own, as well as in conjunction with the engine block.

The principle which is applied in the actuator unit according to the invention is based on the principle of noise suppression by counter-noise. A further identical piezo, connected in parallel with the first, noise-causing piezo, but reversed in its direction of movement, is mounted onto the first piezo. Thus, the two actuator elements (e.g. piezo elements) operate in opposite directions to each other, and the resulting external vibration energy is zero in the ideal case. It is advantageous here that the control electronics can be used unmodified. Moreover, the design of the injection valve does not need to be modified if changes are made to the control electronics. The method can also be used as a supplementary measure to other methods in order to achieve a further noise reduction. Similarly, the structural implementation does not impose any great demands in terms of tolerance or complexity and overhead.

A further advantage of the actuator unit according to the invention comprising its at least two actuator elements is that optionally only one actuator can be activated, while the other actuator remains deenergized. In this way a defined partial stroke of an injection valve or the like can be controlled with a high degree of accuracy. For cost reasons piezo-driven injection valves are normally operated without a control function. In other words, the controller for the piezo actuators is not able to recognize whether the deflection corresponds exactly to the signal strength of the control signal. For this reason different actuator strokes are relatively difficult to maintain. Only the maximum stroke can be defined with sufficient accuracy. In an actuator unit with two actuator elements, on the other hand, a maximum stroke of just one of the actuator elements can be controlled with great accuracy and leads to a stroke which corresponds exactly to half the value of the maximum possible stroke of both actuator elements.

### BRIEF DESCRIPTION OF THE DRAWINGS

The invention will now be explained in more detail with the aid of embodiments and with reference to the accompanying figures, in which:

FIG. 1 shows a first embodiment of an actuator unit according to the invention in a schematic sectional view,

FIG. 2 shows an alternative embodiment of an actuator unit according to the invention in a schematic sectional view,

FIG. 3 shows a further alternative embodiment of an actuator unit according to the invention in a schematic sectional view,

FIG. 4 shows an actuator unit according to the known prior art,

FIG. 5 shows a sound pressure diagram with two exemplary measurement curves, and

FIG. 6 shows a further diagram with three exemplary loudness curves.

### DETAILED DESCRIPTION OF THE PREFERRED EMBODIMENTS

FIG. 4 shows an actuator unit as known from the prior art. In this arrangement, an control device 6, for example an actuator of a servo valve, is deflected via a leverage transmission device 14 by means of an actuator element 8. This actuator element 8 can be, for example, a piezo stack or the like which is supported with a first end face 82 against a corresponding end face of an actuator housing 4. A further end face 83 arranged opposite to the first end face undergoes a change of position in the axial direction of the actuator element 8 as a function of the electrical voltage applied, as indicated by the double arrow 81 along the longitudinal axis of the actuator element 8.

To allow control of the actuator element 8, electrical terminals 18 are provided which are in electrical contact with the individual elements of the actuator element 8 and which stand proud of the first end face 82. A voltage is applied to these electrical terminals 18, thereby causing a longitudinal extension of the actuator element 8. The electrical connection to the control electronics is established via the connector 22.

The actuator unit according to the prior art represented schematically in FIG. 4 causes considerable noise emissions due to the longitudinal movements of the actuator element 8, which are introduced into the internal combustion engine as structure-borne noise via the actuator housing 4 as well as the injector housing 12 permanently connected to this.

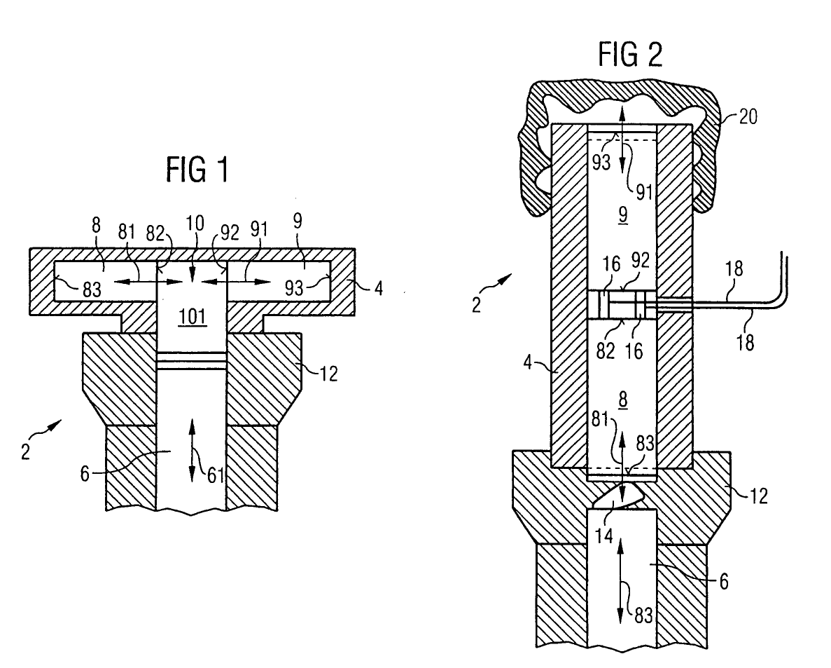

FIG. 1 shows a schematic sectional view of a first embodiment of an actuator unit 2 according to the invention which is characterized by two actuator elements 8, 9 operating in opposite directions. A first actuator element 8 acts with a first end face 82 upon a transmission medium 101 of a hydraulic transmission device 10. A second actuator element 9 acts with a second end face 92 likewise upon the transmission medium 101. First and second actuator element 8, 9 are arranged opposite each other such that a first longitudinal axis 81 of the first actuator element 8 is disposed coincident with a second longitudinal axis 91 of the second actuator element 9. A third end face 83 of the first actuator element 8 is supported in the actuator housing 4. A fourth end face 93 of the second actuator elements 9 is also supported in the actuator housing 4. When electrically activated, the first and second actuator element 8 and 9 each experience a deflection in the opposite direction, with the result that a vectorial sum of the longitudinal movements of the two actuator elements 8, 9 is approximately equal to zero at any given time.

The opposing deflections along the first and second longitudinal axis 81, 91 effect via the transmission medium a longitudinal movement direction 61 of the control device 6 which is normal to the direction of movement of the actuator elements 8, 9. The control device 6 can for example be a control piston of a servo valve of a fuel injector which causes a nozzle needle of the fuel injector to open and close.

The transmission medium 101 of the hydraulic transmission device 10 can be for example a suitable hydraulic oil, for example silicon-based, or the like. The actuator elements 8, 9 must be sealed off from the transmission medium 101 by means of suitable known measures.

FIG. 2 shows a further schematic sectional view of an alternative embodiment of an actuator unit 2 according to the invention. In this case first longitudinal axis 81 of the first actuator element 8, second longitudinal axis 91 of the second actuator element 9 and movement direction 61 of the control device 6 are in each oriented axially parallel to one another. The deflection of the control device 6 is effected via the leverage transmission device 14 essentially by means of the deflection of the first actuator element 8 along its first longitudinal axis 81, while its third end face 83 acts upon the leverage transmission device 14. The first end face 82 of the first actuator element 8 is immovably supported in the actuator housing 4. The second end face 92 of the second actuator elements 9 is permanently connected to the first end face 82 of the first actuator element 8 via two supports 16. At the same time the electrical terminals of the two actuator elements 8, 9 are integrated into the supports 16, to which a voltage is applied via electrical terminals 18.

When a voltage is applied, the third and fourth end faces 83, 93 of the actuator elements 8, 9 each move by the same amount in opposite directions. In this way a resulting mass impulse caused by the deflection of just one actuator element (e.g. 8) is largely dampened by the respective second actuator element (e.g. 9). A structure-borne noise excitation can likewise be greatly reduced in this way. On a top surface of the actuator housing 4 facing the fourth end face 93 of the second actuator elements 9 there is further provided a cover 20 which closes off the second actuator element 9 externally and which also effects a passive soundproofing of the actuator housing 4.

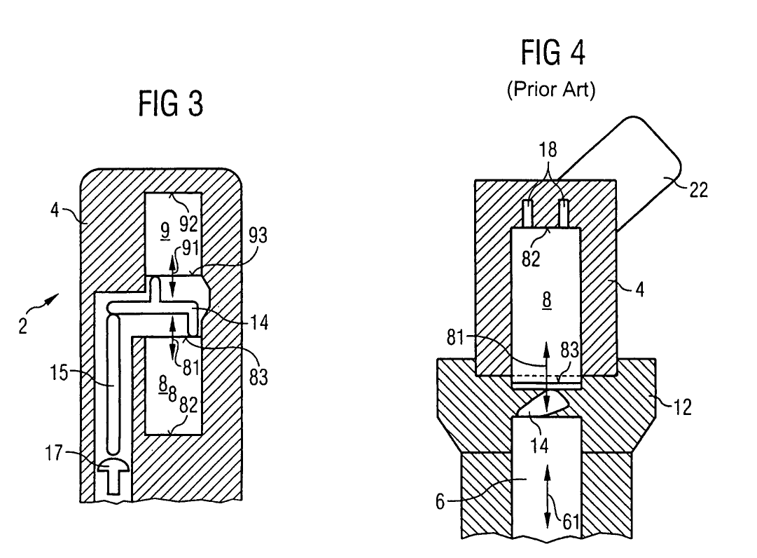

FIG. 3 shows a schematic view of a third alternative embodiment of an actuator unit 2 according to the invention. In this case first longitudinal axis 81 of the first actuator element 8, second longitudinal axis 91 of the second actuator element 9 and a direction of movement of a stroke transmission rod 15 as well as a valve mushroom 17 of a hydraulic servo valve are each oriented axially parallel to one another. The deflection of the stroke transmission rod 15 is effected via the leverage transmission device 14 in equal proportions by the deflections of the actuator elements 8, 9 along their longitudinal axes 81, 91. The first end face 82 of the first actuator element 8 and the second end face 92 of the second actuator element 9 are supported in each case immovably in the actuator housing 4.

When a voltage is applied, the third and fourth end faces 83, 93 of the actuator elements 8, 9 each move by the same amount in opposite directions. In this way a resulting mass impulse caused by the deflection of just one actuator element (e.g. 8) is largely suppressed by the respective second actuator element (e.g. 9). A structure-borne noise excitation can likewise be greatly reduced in this way.

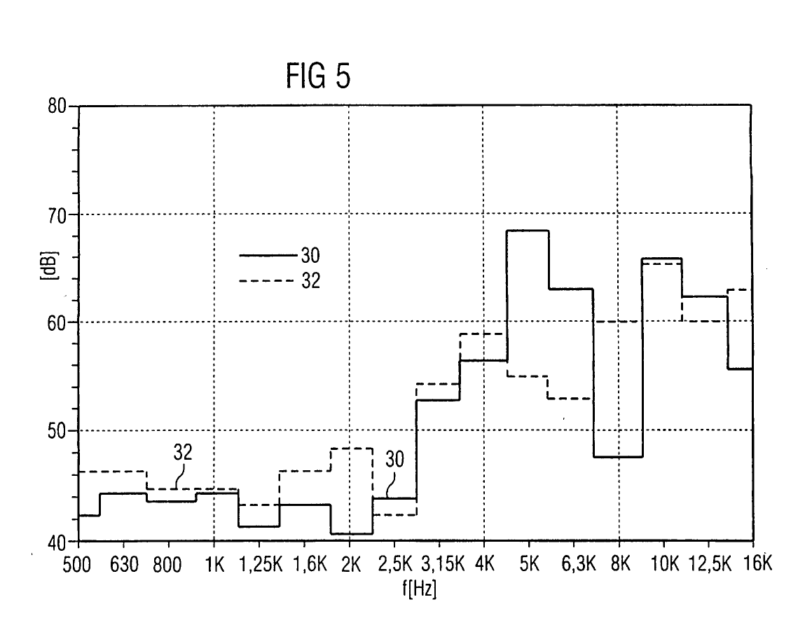

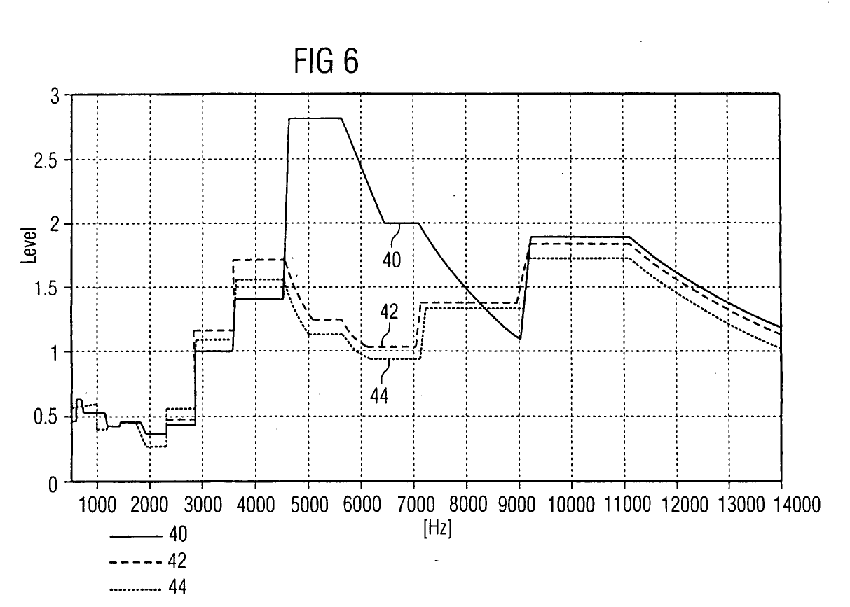

FIG. 5 shows in exemplary measurement curves 30, 32 a comparison of a conventional injector (according to FIG. 4) with an optimized injector according to the second embodiment of the invention (according to FIG. 2). Currently, injection valves and their piezo actuators are operated at a typical energy of approx. 35 mJ to approx. 70 mJ. In order to generate the same kinetic energy in the opposite direction for the purpose of noise suppression, a second piezo element in turn requires the same amount of energy.

In the measurement shown in FIG. 5, as an example one injector was operated at 48.5 mJ and the optimized injector correspondingly at 97 mJ. In spite of a greatly increased energy input a significant reduction in noise emission can be demonstrated in the relevant frequency range of approx. 4 kHz to 8 kHz.

The first sound pressure curve 30 characterizes the sound pressure of a conventional injector (cf. FIG. 3) in decibels over a frequency between 500 Hz and 16 kHz. The second sound pressure curve 32 illustrates the sound pressure waveform of the optimized actuator unit according to FIG. 2. Although the double piezo increases the level at the 8 kHz Terz (third octave), it reduces it considerably at the 5 kHz and 6.3 kHz Terz, which leads overall to a total level reduction of up to 4 dB (A).

Taking into account psychoacoustic effects, loudness as a normalized variable is most meaningful in terms of sound character and nuisance perception.

FIG. 6 therefore shows three different loudness curves 40, 42, 44 to illustrate the effects of different embodiments of a piezo actuator on the perceived loudness.

The first loudness curve 40 characterizes an injection valve of conventional design. The emphasis in the range 4 kHz to 6 kHz is obvious in this case. Compared with this, measurements were conducted on an injection valve with double piezo, where the second loudness curve represents an injector without plastic extrusion coating (cover 20 in FIG. 2) and the third loudness curve 44 represents the same injector with a light foil cover. This cover was chosen because the plastic extrusion coating also causes a slight dampening of the directly radiated sound waves of the moving surface of the piezos.

From the loudness test it is clear that the minimum at the 8 kHz Terz (third octave) with the conventional injector plays virtually no role and within this third octave neither optimization nor worsening would cause a serious change, since the 6.3 kHz Terz almost completely covers this optimization. Thus, the considerably higher level at this Terz with the injector having the double piezo represents no negative effect on the acoustic pattern.

I claim:

1. An actuator unit comprising at least two actuator elements which when electrically activated each experience a change in length, which are connected to a control device by means of an interactive connection, and an actuator housing which encloses the actuator elements and which is connected to the actuator elements by means of a positive and/or friction fit, wherein a vectorial sum of the mass impulses of the at least two actuator elements is approximately zero at any given time.

2. The actuator unit according to claim 1, wherein a first and a second actuator element are each disposed essentially opposite each other with intersecting longitudinal axes.

3. The actuator unit according to claim 1, wherein a vectorial sum of the longitudinal movements of the at least two actuator elements is approximately zero at any given time.

4. The actuator unit according to claim 1, wherein a first and a second actuator element are each disposed opposite each other with coincident longitudinal axes.

5. The actuator unit according to claim 1, wherein a first and a second end face of the first and second actuator element respectively are supported in the actuator housing, and a third and fourth end face of the actuator elements respectively act upon a transmission medium.

6. The actuator unit according to claim 5, wherein the transmission medium is part of a transmission device and acts upon the control device.

7. The actuator unit according to claim 5, wherein the transmission medium is part of a hydraulic transmission device and acts upon the control device.

8. The actuator unit according to claim 6, wherein the transmission medium is part of a hydraulic transmission device and acts upon the control device.

9. The actuator unit according to claim 5, wherein the direction of the axial movements of the first and second actuator elements is oriented essentially normal to the direction of movement of the control device.

10. The actuator unit according to claim 1, wherein the first and the second end face of the first and second actuator element respectively is supported in the actuator housing and the third end face of the first actuator element acts directly or indirectly upon the control device.

11. The actuator unit according to claim 10, wherein the directions of the axial movements of the first and second actuator element as well as the direction of movement of the control device are oriented in each case axially parallel to one another.

12. The actuator unit according to claim 1, wherein each of the actuator elements is a piezoelectric actuator element.

13. The actuator unit according to claim 1, wherein each of the actuator elements is a magnetostrictive actuator element.

14. The actuator unit according to claim 1, wherein the actuator unit is an actuator of a fuel injection valve.

15. The actuator unit according to claim 1, wherein the actuator elements of the actuator unit can be controlled separately from each other and individually.
